(19) United States
(12) Patent Application Publication
(10) Pub. No.: US 2008/0098170 A1
(43) Pub. Date: Apr. 24, 2008

(54) System and method for incremental RPO-type algorithm in disk drive

(76) Inventors: William L. Guthrie, San Jose, CA (US); Joe-Ming Cheng, Cupertino, CA (US); Nyles Norbert Heise, San Jose, CA (US)

Correspondence Address: ROGITZ & ASSOCIATES, 750 B STREET, SUITE 3120, SAN DIEGO, CA, 92101, US

(21) Appl. No.: 11/584,824

(22) Filed: Oct. 23, 2006

(51) Int. Cl. G06F 13/00

(52) U.S. Cl. 711/113

(57) ABSTRACT

A desired cache size in a disk drive is established, and no reordering algorithm is performed on commands in the cache until the desired size is reached. An optimal subset size is also established. Then, an optimization algorithm is performed on all commands in the cache, with only the commands in the optimal subset being output for execution. The cache is refilled to the desired size, and the process is repeated.

### FIELD OF THE INVENTION

The present invention relates generally to disk drives, and in particular to hard disk drives (HDD).

### BACKGROUND OF THE INVENTION

In hard disk drives, when there are more than one command to execute, the data to be accessed next is chosen from a list or a queue of outstanding commands, typically in a solid state cache that may be implemented by, e.g., a dynamic random access memory (DRAM) or from a section (referred to as “L2”) of the disk that might be dedicated to cache-like functions, as set forth in, e.g., U.S. Pat. No. 6,378,037, incorporated herein by reference. In any case, when a hard disk drive has more than one command to execute, the commands are placed in a cache-implemented queue from which the next command is chosen. A Rotational Position Optimization (RPO) algorithm is used to reorder the commands for execution for optimal efficiency.

Several variations have been proposed to the RPO paradigm. For instance, U.S. Pat. No. 6,859,859, incorporated herein by reference, discloses an effective RPO (“e-RPO”) method of command queue ordering in which, for each command in a command queue, an access time is calculated by identifying a probability of miss and adding a penalty for the identified probability of miss to the calculated access time. A command in the command queue having a best access time is identified and executed. Another variation is the so-called “n-RPO” method in which groups of commands are evaluated to maximize the number of queue commands that can be executed in a given number of disk revolutions. Yet another variation might combine the e-RPO and n-RPO methods.

As critically recognized herein, many types of RPO-based algorithms happen to work more efficiently when the pool of available commands is large. Write caching and L2 caching increase the effective command set available to the RPO-based algorithms. The number of commands that can be placed in the write cache or L2 cache is limited by system resources. The cache must be effectively managed to optimize throughput. With this critical recognition in mind, the invention herein is provided.

### SUMMARY OF THE INVENTION

A controller for a hard disk drive that has a cache and at least one disk includes logic that, before outputting commands from the cache for execution to disk, fills the cache to a desired number of commands. When the cache stores the desired number of commands, the logic evaluates all commands in the cache using an execution optimization algorithm such as, e.g., a greedy algorithm, a NRPO algorithm, etc. The logic executes only an optimal subset of commands evaluated by the execution optimization algorithm, removing from cache only commands in the optimal subset, and leaving remaining commands in the cache. The cache is then refilled to the desired number of commands prior to once again using the execution optimization algorithm to identify a new optimal subset of commands.

The optimal subset may be based on age of commands, most number of commands that can be executed in a predetermined time period, most number of commands that can be executed in a predetermined number of rotations of the disk, locations on the disk associated with the commands, or other heuristics. The cache may be implemented in solid state memory or on the disk itself.

In another aspect, a data storage device has a disk, a data cache, and means for determining when a number of commands in the cache reaches a desired size. The device also includes means, responsive to the means for determining, for identifying a subset number of commands smaller than the desired size for execution.

In yet another aspect, a disk drive controller receives commands into a cache and executes commands in the cache to disk. The controller includes logic implementing a command execution algorithm only when a desired cache size has been reached and executing only a subset of the commands less than the desired cache size prior to refilling the cache to the desired cache size. The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting HDD implementation of the present invention; and

FIG. 2 is a flow chart of the logic.

### DETAILED DESCRIPTION OF THE PREFERRED EMBODIMENT

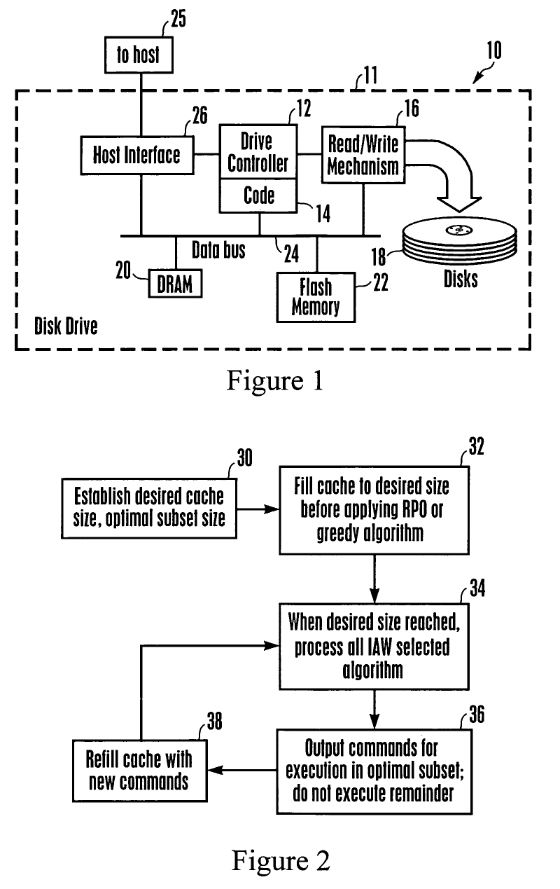

Referring initially to FIG. 1, a hard disk drive (HDD) is shown, generally designated 10, having a housing 11 holding a hard disk drive controller 12 that can include and/or be implemented by a microcontroller on a chip. The controller 12 may access electronic data storage in a computer program device or product such as but not limited to a microcode storage 14 that may be implemented by a solid state memory device. The microcode storage 14 can store microcode embodying the logic discussed further below.

The HDD controller 12 controls a read/write mechanism 16 that includes one or more heads for writing data onto one or more disks 18. Non-limiting implementations of the HDD 10 include plural heads and plural disks 18, and each head is associated with a respective read element for, among other things, reading data on the disks 18 and a respective write element for writing data onto the disks 18.

The HDD controller 12 communicates with solid state memory. One such solid state memory may be volatile memory such as a Dynamic Random Access Memory (DRAM) device 20. Also, the controller 12 may communicate with solid state non-volatile memory, preferably a flash memory device 22, over an internal HDD bus 24. The HDD controller 12 also communicates with an external host computer 25 through a host interface module 26 in accordance with HDD principles known in the art. The host computer 25 can be a portable computer that can be powered by a battery, so that the HDD 10 can be a mobile HDD. The controller 12 with, e.g., DRAM 20 may be mounted on a HDD motherboard in accordance with principles known in the art.

As stated above, the logic disclosed below may be contained in a code storage 14 that is separate from the HDD controller 12, or the storage 14 may be integrated into the controller 12. Or, it may be contained in the read/write mechanism 16, or on the DRAM 20 or flash memory device 22. The logic may be distributed through the components mentioned above, and may be implemented in hardware logic circuits and/or software logic circuits.

Now referring to FIG. 2, the present logic can be seen. Commencing at block 30, a desired cache size “N” and an optimal subset size “n”, which is less than the desired cache size “N”, are established. The sizes may be in terms of numbers of commands or total storage size. The optimal subset size “n” may be based on, e.g., age of commands, specifically, the optimal subset size may be based on a desire to execute a predetermined number of commands of age greater than some predetermined time period. Or, the optimal subset size “n” may be based on the highest number of commands that can be executed in a predetermined time period. Yet again, the optimal subset size “n” can be based on the greatest number of commands that can be executed in a predetermined number of rotations of the disk, or based on locations on the disk associated with the commands.

Block 32 indicates that before outputting commands from the cache for execution to disk, the cache is filled to the desired cache size “N”. When the desired cache size “N” is reached, i.e., when the cache stores the desired number of commands, at block 34 substantially all “N” commands in the cache are evaluated using an execution optimization algorithm such as a greedy algorithm or a n-RPO algorithm, including expected NRPO algorithms.

Block 36 indicates that of the “N” commands evaluated by the algorithm, only the “n” commands best fitting the criteria that were used to establish the optimal subset size “n” are executed to disk. These “n” commands may then be removed from the cache, but the remaining “N”-“n” commands remain in cache. At block 38 the cache is refilled to the desired number “N” of commands prior to once again using an execution optimization algorithm to identify the “n” commands in the next successive optimal subset.

The cache may be implemented in, e.g., the DRAM 20 or other solid state memory, or it may be implemented on a set-aside portion of the disk.

The above strategies may be combined. For instance, if it is determined that the optimal subset size will be the greatest number of commands that can be executed to disk in four disk revolutions, then the optimization algorithm will output, as its “top twenty” commands, those fitting the selection criteria. This can be modified by requiring that any command in cache that has been there longer than a predetermined period of time must be included in the next execution batch, potentially bumping one of the commands that would otherwise be in the optimal subset back into the queue for the next processing cycle.

The “n” commands in the subset and only those commands may be output as a group by the optimization algorithm, or all “N” commands may be ordered and output by the optimization algorithm, in which case only the top “n” commands are executed. The remaining commands are evaluated once again in the next cycle, i.e., with the new “n” commands that have been added to bring the cache size back up to “N”.

While the particular SYSTEM AND METHOD FOR INCREMENTAL RPO-TYPE ALGORITHM IN DISK DRIVE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A controller chip for a hard disk drive having at least one cache and at least one disk, comprising logic executing method acts including:
before outputting commands from the cache for execution to disk, filling the cache to a desired number of commands;
when the cache stores the desired number of commands, evaluating substantially all commands in the cache using an execution optimization algorithm;
executing only an optimal subset of commands evaluated by the execution optimization algorithm, removing from cache only commands in the optimal subset, and leaving remaining commands in the cache; and
refilling the cache to the desired number of commands prior to once again using an execution optimization algorithm.

2. The chip of claim 1, wherein the optimal subset is based on age of commands.

3. The chip of claim 1, wherein the optimal subset is based on most number of commands that can be executed in a predetermined time period.

4. The chip of claim 1, wherein the optimal subset is based on most number of commands that can be executed in a predetermined number of rotations of the disk.

5. The chip of claim 1, wherein the optimal subset is based on locations on the disk associated with the commands.

6. The chip of claim 1, wherein the algorithm is a greedy algorithm

7. The chip of claim 1, wherein the algorithm is a n-RPO algorithm.

8. The chip of claim 1, wherein the cache is implemented in solid state memory.

9. The chip of claim 1, wherein the cache is implemented on a portion of the disk.

10. A data storage device comprising:
at least one storage disk;
at least one data cache;
means for determining when a number of commands in the cache reaches a desired size; and
means, responsive to the means for determining, for identifying a subset number of commands smaller than the desired size for execution.

11. The device of claim 10, comprising means for executing the subset without executing additional commands in the cache prior to the means for determining once again determining when the number of commands in the cache reaches the desired size.

12. The device of claim 10, wherein the subset is based on age of commands.

13. The device of claim 10, wherein the subset is based on most number of commands that can be executed in a predetermined time period and/or based on most number of commands that can be executed in a predetermined number of rotations of the disk.

14. The device of claim 10, wherein the subset is based on locations on the disk associated with the commands.

15. The device of claim 10, wherein the algorithm is a greedy algorithm.

16. The device of claim 10, wherein the algorithm is a n-RPO algorithm.

17. The device of claim 10, wherein the cache is implemented in solid state memory.

18. The device of claim 10, wherein the cache is implemented on a portion of the disk.

19. A disk drive controller receiving commands into a cache and executing commands in the cache to disk, comprising:
logic implementing a command execution algorithm only when a desired cache size has been reached and executing only a subset of the commands less than the desired cache size prior to refilling the cache to the desired cache size.

20. The controller of claim 19, wherein the subset is based on age of commands.

21. The controller of claim 19, wherein the subset is based on most number of commands that can be executed in a predetermined time period.

22. The controller of claim 19, wherein the subset is based on most number of commands that can be executed in a predetermined number of rotations of the disk.

23. The controller of claim 19, wherein the subset is based on locations on the disk associated with the commands.

24. The controller of claim 19, wherein the algorithm is a greedy algorithm.

25. The controller of claim 19, wherein the algorithm is a n-RPO algorithm.
